(19) United States
(12) Patent Application Publication
(10) Pub. No.: US 2021/0060920 A1
(43) Pub. Date: Mar. 4, 2021

(54) Progressive Non-Through Hole Glass Screen Protector and Manufacturing Method Thereof

(71) Applicant: J-TING CO., LTD, Taipei City (TW)

(72) Inventor: HSIN-HUNG KUO, Taipei City (TW)

(21) Appl. No.: 16/914,440

(22) Filed: Jun. 28, 2020

(30) Foreign Application Priority Data
Aug. 28, 2019 (TW) 108130925

(51) Int. Cl. B32B 37/18; C03C 19/00; C03C 17/00; C03B 19/09; B32B 7/12; B32B 3/26; B32B 17/06; B32B 37/12; B32B 38/00; C03C 21/00; B24B 7/24

(52) U.S. Cl. CPC B32B 37/18; B32B 2457/202; C03C 17/002; C03B 19/09; B32B 7/12; B32B 3/263; B32B 17/06; B32B 37/12; B32B 38/0004; B32B 38/0012; C03C 21/002; B24B 7/24; B32B 2038/0064; B32B 2255/00; B32B 2305/08; B32B 2307/558; B32B 2315/08; C03C 19/00

(57) ABSTRACT

A glass screen protector manufacturing method of a progressive non-through hole glass screen protector includes the steps of cutting a glass screen protector pattern; CNC machining the glass screen protector for a side edge, a progressive sensing area, and a desired hole position thereof; polishing the glass screen protector; reinforcing the glass screen protector; coating the glass screen protector with a nano coating; and gluing a backing to the glass screen protector.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention relates to the field of glass screen protector, and, in particular, to a progressive non-through hole glass screen protector and manufacturing method thereof, wherein when the glass screen protector is applied on a portable mobile electronic device, the glass screen protector is capable of increasing the sensibility of the fingerprint reader or sensing element without having a through hole or impact to the appearance.

### Description of Related Arts

As science and technology advance by leaps and bounds, it produces a golden age of the development of portable mobile electronic device and relative products, especially in the field of smart communication and relative accessories. The users pay much attention to the brand, specifications, and quality of the portable mobile electronic devices, and even more attention to the selection of the accessories of the portable mobile electronic device because the utilization of the accessories may impact the performance of the portable mobile electronic device. In other words, it will get more kicks than halfpence if an user selects an accessory of lower quality or grade which impacts the performance and high effectiveness of his/her portable mobile electronic device.

Particularly, common accessories of a portable mobile electronic device include protective shell, glass screen protector, charging accessories, and etc. The present invention will focus on the improvement to conventional glass screen protectors, so as to solve the issues that conventional glass screen protectors have. One of the most common issues for conventional glass screen protectors is that the thickness of the glass screen protector affects the sensibility of the operation of a portable mobile electronic device when the glass screen protector is attached on the portable mobile electronic device. Further, according to prior patents, the thickness of the entire glass is 0.2 mm-0.33 mm. Unfortunately, it will render the sensibility special sensing element, such as the fingerprint reader, fail or perform poorly. Accordingly, there have been solutions for the prior arts, but there are some other drawbacks in these solutions as well.

Particularly, according to some prior patent, there is an improvement for the backing of the glass screen protector. For example, it thins the overall thickness of the adhesive on the back of the glass screen protector. Unfortunately, it causes a drawback that the whole adhesive becomes too thin, rendering uneven thickness of the adhesive when the backing device clamped. As a result, bubbles or gum streaks are likely to occur when the glass screen protector is attached on the display of the portable mobile electronic device, which will impact the attachment and compactness between the glass screen protector and the display as well as cause poor appearance. Besides, according to some other prior arts, the backing is thinned through partially thinning the Epoxy Resin AB Glue or UV adhesive as the backing of the glass screen protector. Nonetheless, this will prevent the thickness of the glass from being further reduced, which still fails to maintain a stable sensibility of the special sensing element, such as the fingerprint reader. In addition, according to some other prior arts, there is no backing disposed at the area of the fingerprint reader on the glass screen protector. Namely, the glass screen protector does not have backing at that area. Nevertheless, this will have the glass screen protector directly contact the display and therefore, possibly scratch the display as well as render Newton's ring and poor appearance. In other words, there will be an obvious mark occur between the backing-free area of the glass screen protector and the rest of backing area of the glass screen protector, which creates inartistic appearance.

Moreover, according to some other prior arts, the solution is to open a hole on the glass screen protector at the position corresponding to the fingerprint reader. In other words, in order not to affect the sensing of the special sensing element, such as the fingerprint reader, conventional glass screen protectors usually provide a through hole opened thereon at the position corresponding to the sensing area of the special sensing element. However, such practice will not only impact the wholeness as well as the appearance of the glass screen protector, but also render other drawbacks, including dust accumulation, head scratch risk, poor texture, and hole look of the display. Moreover, according to some prior patents, there is hole opened at the position corresponding to the position of a proximity sensor. Similarly, this type of arrangement can affect the wholeness and beauty of the glass screen protector and is likely to render dust accumulation.

It is worth mentioning that in order to solve the poor sensibility issue caused by the glass screen protector, some other prior art choose to thin the entire glass screen protector, such as turning its entire thickness into 0.1 mm-0.2 mm. It is easy to understand that such arrangement will lower the overall strength and the fringe strength of the glass screen protector. The user may crack the glass screen protector only by a gentle bump. Therefore, it can barely protect the portable mobile electronic device effectively. Furthermore, according to some prior patents, it substitutes the glass screen protector with a thin PET plastic film. Similarly, this means cannot provide effective protection to the portable mobile electronic device, such as a cellphone. When the device is dropped, it cannot protect the plate of the display from cracking.

It is understandable that modern people mostly cannot live without smart communication devices or portable mobile electronic devices. Hence, the ways to enhance the performance of the smart communication devices or portable mobile electronic devices have been cared about by both the manufacturers and users. As mentioned above, it can be noted there are various conventional solutions for glass screen protector, but they all have obvious drawbacks. That is to say, they somehow improve the utilization of the fingerprint reader, but create some other new problems as well. Nevertheless, the present invention certainly provides improvement on the above issues and enhances the sensibility of the operations of the fingerprint or other sensing elements when the user is utilizing a smart communication device or portable mobile electronic device.

### SUMMARY OF THE PRESENT INVENTION

An object of the present invention is to provide a progressive non-through hole glass screen protector and manufacturing method thereof, wherein the glass screen protector has a part of progressively thinner glass and has no through hole, so as not to affect the fingerprint reader or other electronic sensing elements of a portable mobile electronic device, such as cellphone, tablet computer, iPad, and etc. For instance, when the user is utilizing a portable mobile electronic device that has the progressive non-through hole glass screen protector of the present invention be attached thereon, s/he can sensibly operate the fingerprint function for unlocking the device. In other words, the sensibility of the area of the fingerprint element is enhanced at the corresponding position on the glass screen protector.

An object of the present invention is to provide a progressive non-through hole glass screen protector and manufacturing method thereof, wherein the glass screen protector has no through hole and no offset at the position of the fingerprint reader or electronic sensing element, so that the user always has feelings of level, artistic, premium, smooth, dust-proof, scratch-free, hole-free look, and etc. when touching the fingerprint position of the glass screen protector.

An object of the present invention is to provide a progressive non-through hole glass screen protector and manufacturing method thereof, wherein one of the biggest advantages of the glass screen protector is that it only partially reduces the thickness of the glass under a hole-free condition, so as not to impact the sensibility of the electronic sensing element of the portable mobile electronic device (i.e. the proximity sensor below the cellphone display). In other words, the glass screen protector of the present invention may be disposed at the fingerprint position or the position of the proximity sensor of the cellphone display, such that the glass screen protector can be partially thinner and not to affect the sensing.

An object of the present invention is to provide a progressive non-through hole glass screen protector and manufacturing method thereof, wherein the glass screen protector has part of the area of the display corresponding to the position where a fingerprint reader is arranged being progressive thinner in a funnel-like manner (i.e. the thickness of the glass screen protector is partially reduce at the area) rather than having through hole, so that the strength of the edge of the glass will not be affected and offset rendered by blind hole can be avoided as well. In other words, the overall appearance of the progressive non-through hole glass screen protector of the present invention will not be affected.

An object of the present invention is to provide a progressive non-through hole glass screen protector and manufacturing method thereof, wherein the glass screen protector has part of the area of the display corresponding to the position where a fingerprint reader is arranged being curvedly and progressive thinner (i.e. the thickness of the glass screen protector is partially reduce at the area) rather than having through hole, so that the strength of the edge of the glass will not be affected and offset rendered by blind hole can be avoided as well. In other words, the overall appearance of the progressive non-through hole glass screen protector of the present invention will not be affected.

Additional advantages and feature of the present invention will become obvious through the following descriptions and they can be achieved through the means and combinations specified in the appended claims.

In order to achieve at least one of the objects of the present invention, the present invention provides a glass screen protector manufacturing method, including the steps of:

(A) cutting a glass screen protector pattern;

(B) CNC machining the glass screen protector for a side edge, a progressive sensing area, and a desired hole position thereof;

(C) polishing the glass screen protector;

(D) reinforcing the glass screen protector;

(E) coating the glass screen protector with a nano coating; and

(F) gluing a backing to the glass screen protector.

According to an embodiment of the present invention, in the step (A), the pattern and size of the glass screen protector is determined by the LCD panel of the portable mobile electronic device.

According to an embodiment of the present invention, in the step (A), the glass screen protector is made of the material selected from the group consisting of sapphire crystal glass, ceramics glass, sitall glass, aluminosilcate glass, soda-lime glass, and combinations thereof.

According to an embodiment of the present invention, in the step (B), the position of the progressive sensing area on the glass screen protector, which is corresponding to the position of the electronic sensing element below the LCD panel of the portable mobile electronic device, is confirmed before CNC machining.

According to an embodiment of the present invention, in the step (B), a CNC tool is utilized for processing the glass screen protector and forming the progressive sensing area.

According to an embodiment of the present invention, in the step (B), the CNC tool moves according to input designated directions so as to provide a progressive funnel gentle slope, which allows various periphery patterns to be programed in order to partially cut the thickness of the progressive sensing area of the glass screen protector in different extents.

According to an embodiment of the present invention, in the step (B), the progressive sensing area is in a non-through hole progressive shape after the CNC machining.

According to an embodiment of the present invention, in the step (B), the peripheral outline of the progressive sensing area is in a shape selected from the group consisting of square, rectangle, circle, oval, trapezoid, inequilateral shape, and combinations thereof after the CNC machining.

According to an embodiment of the present invention, in the step (B), after the CNC machining, the progressive sensing area has a periphery, a sloping side, and a bottom side, wherein the sloping side is smoothly connected between the periphery and the bottom side, wherein the periphery has a smooth arc angle, so as to eliminate the offset between the sloping side and the upper surface of the main body of the glass screen protector, wherein the sloping side is curvy or plane, wherein the bottom side is curvy or plane.

According to an embodiment of the present invention, the minimum thickness of the progressive sensing area is 0.01 mm.

According to an embodiment of the present invention, in the step (C), the glass screen protector has an integral and consistent glossy surface through a partial or whole polishing to the glass screen protector.

According to an embodiment of the present invention, in the step (D), the strength and toughness of the glass screen protector is enhanced through high-temperature furnace and potassium nitrate process.

According to an embodiment of the present invention, in the step (E), the upper surface of the glass screen protector is processed with AS/AF nano coating.

According to an embodiment of the present invention, in the step (F), the backing is selected from the group consisting of epoxy resin AB glue, non-backing UV glue, optical adhesive, and combinations thereof.

In order to achieve at least one of the objects of the present invention, the present invention provides another glass screen protector manufacturing method, including the steps of:

(a) providing glass frit into a mold so as to form an integral glass screen protector, which has a main body and a progressive sensing area arranged thereon;

(b) reinforcing the glass screen protector;

(c) coating the glass screen protector with a nano coating; and

(d) gluing a backing to the glass screen protector.

According to the step (a) of an embodiment of the present invention, the mold has a mold cavity for the glass screen protector, which size is corresponding to the size of the LCD panel of the portable mobile electronic device.

According to an embodiment of the present invention, in the step (a), the progressive sensing area has a periphery, a sloping side, and a bottom side, wherein the sloping side is smoothly connected between the periphery and the bottom side, wherein the periphery has a smooth arc angle, so as to eliminate the offset between the sloping side and the upper surface of the main body of the glass screen protector, wherein the sloping side is curvy or plane, wherein the bottom side is curvy or plane.

According to the step of an embodiment of the present invention, the glass screen protector has a curvy trim.

In order to achieve at least one of the objects of the present invention, the present invention also provides an alternative mode of the glass screen protector manufacturing method, including the steps of:

(a′) providing glass frit into a mold so as to form an integral glass screen protector;

(b′) CNC machining the glass screen protector for a progressive sensing area and a desired hole position thereof;

(c′) polishing the glass screen protector;

(d′) reinforcing the glass screen protector;

(e′) coating the glass screen protector with a nano coating; and

(f) gluing a backing to the glass screen protector.

According to an embodiment of the present invention, in the step (b′), after the CNC machining, the progressive sensing area has a periphery, a sloping side, and a bottom side, wherein the sloping side is smoothly connected between the periphery and the bottom side, wherein the periphery has a smooth arc angle, so as to eliminate the offset between the sloping side and the upper surface of the main body of the glass screen protector, wherein the sloping side is curvy or plane, wherein the bottom side is curvy or plane.

In order to illustrate the features, advantages, and content more clearly, preferred embodiments will be provided as follows in addition to the drawings for detail descriptions.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a portable mobile electronic device and a progressive non-through hole glass screen protector according to a preferred embodiment of the present invention.

FIGS. 2A and 2B are sectional views of a portable mobile electronic device and the progressive non-through hole glass screen protector according to the above preferred embodiment of the present invention. FIG. 2A illustrated the glass screen protector and the portable mobile electronic device in a separated state. FIG. 2B illustrated the glass screen protector and the portable mobile electronic device in a coupled state.

FIG. 3 is a front perspective view of the progressive non-through hole glass screen protector according to the above preferred embodiment of the present invention.

FIG. 4 is a sectional and partially enlarged view of the progressive non-through hole glass screen protector according to the above preferred embodiment of the present invention, illustrating that the sloping side and the bottom side of the progressive sensing area are curvy.

FIG. 5 is a sectional and partially enlarged view of the progressive non-through hole glass screen protector according to the above preferred embodiment of the present invention, illustrating, illustrating that the sloping side of the progressive sensing area is plane and the bottom side is curvy.

FIG. 6 is a sectional and partially enlarged view of the progressive non-through hole glass screen protector according to the above preferred embodiment of the present invention, illustrating that the sloping side and the bottom side are plane.

FIG. 7A is a perspective view illustrating the progressive non-through hole glass screen protector, in a pre-process state, being manufactured through CNC tools according to the above preferred embodiment of the present invention.

FIG. 7B is a perspective view illustrating the progressive non-through hole glass screen protector, in a post-process state, being manufactured through CNC tools according to the above preferred embodiment of the present invention.

FIG. 8A is a perspective view illustrating the progressive non-through hole glass screen protector being manufactured through mold according to the above preferred embodiment of the present invention, wherein the mold in an open state.

FIG. 8B is a perspective view illustrating the progressive non-through hole glass screen protector being manufactured through mold according to the above preferred embodiment of the present invention, wherein the mold in a close state.

FIGS. 9-11 are flow charts of the manufacturing methods of the progressive non-through hole glass screen protector according to the above embodiment of the present invention.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

Those skilled in the art should understand that, in the disclosure of the present invention, terminologies of “longitudinal,” “lateral,” “upper,” “front,” “back,” “left,” “right,” “perpendicular,” “horizontal,” “top,” “bottom,” “inner,” “outer,” and etc. just indicate relations of direction or position are based on the relations of direction or position shown in the appended drawings, which is only to facilitate descriptions of the present invention and to simplify the descriptions, rather than to indicate or imply that the referred device or element must apply specific direction or to be operated or configured in specific direction. The terminology “same” refers to “essentially equal,” in which “essentially” refers to “most but not all of the content that is referred to.” For example, a structure with tolerances may still be considered the same structure. Hence, the above terminologies disclosed in the present invention shall not be considered limitations to the present invention.

It is understandable that the term “a” should be understood as “at least one” or “one or more”. In other words, in one embodiment, the number of an element can be one and in other embodiment the number of the element can be greater than one. The term “a” is not construed as a limitation of quantity.

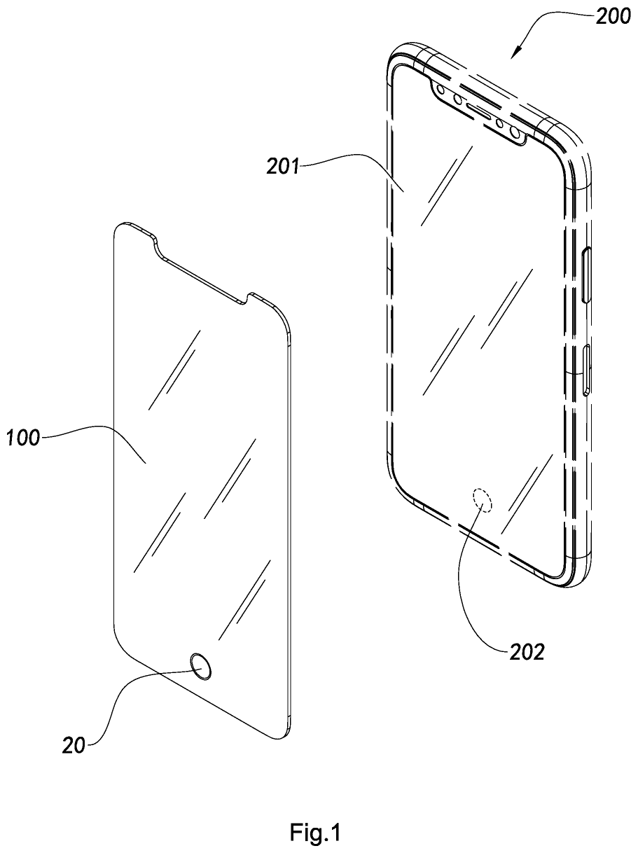

FIGS. 1-8 illustrate a progressive non-through hole glass screen protector 100 and manufacturing method thereof according to a preferred embodiment of the present invention, wherein the glass screen protector 100 is suitable for a smart communication device or portable mobile electronic device 200 in order for protecting the display of the smart communication device or portable mobile electronic device and enhancing the sensibility of the utilization thereof. Especially, the glass screen protector 100 of the present invention enhances its utility and performance without changing its strength or appearance and without hole breakout or through hole.

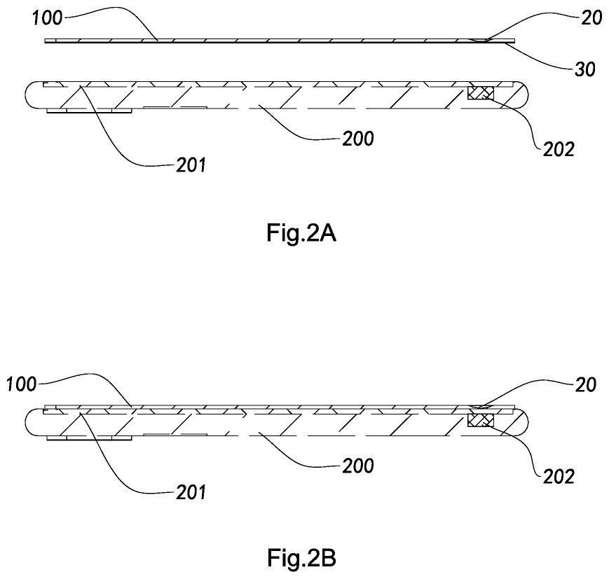

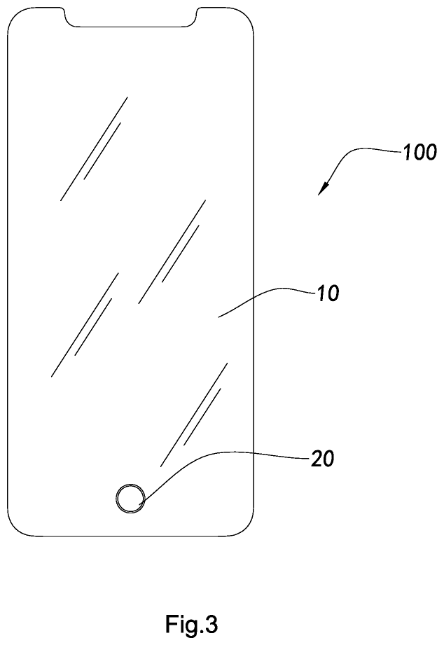

Referring to FIG. 1, the glass screen protector 100 of the present invention is suitable for the smart communication device or portable mobile electronic device 200, in order not to affect its operations, wherein the portable mobile electronic device 200 can be embodied as a smart phone, iPad, tablet computer, and etc., wherein the present invention shall not be limited here. The portable mobile electronic device 200 comprises a LCD panel 201 and at least an electronic sensing element 202. Referring to FIG. 2A-2B, the electronic sensing element 202 is arranged below the LCD panel 201, such that the user can control or operate corresponding functions of the portable mobile electronic device 200 through the electronic sensing element 202. In other words, the user or operator may directly operate the portable mobile electronic device 200 on the LCD panel 201 at the area corresponding to the electronic sensing element 202. The electronic sensing element 202 can be embodied as a fingerprint reader, proximity sensor, and etc., wherein the present invention shall not be limited here. In addition, the portable mobile electronic device 200 also comprises a control unit, at least a camera module, various electronic components, and a housing. Because the portable mobile electronic device 200 is a common electronic device with complicated structure, the present invention will not further illustrate the structures or functions thereof. It is understandable that the structures or functions of the portable mobile electronic device 200 will not affect the arrangement of the present invention.

According to the present embodiment of the present invention, as illustrated in FIG. 3, the glass screen protector 100 of the present invention is attached on the LCD panel 201 of the portable mobile electronic device 200, so as to protect the LCD panel 201 and enhance the sensibility of the utilization thereof. Particularly, the glass screen protector 100 has a main body 10 and at least a progressive sensing area 20, wherein the size of the main body 10 is mostly equal to the size of the LCD panel 201 of the portable mobile electronic device 200. Referring to FIG. 2B, when the glass screen protector 100 is attached on the LCD panel 201 of the portable mobile electronic device 200, the progressive sensing area 20 is at the position corresponding to the electronic sensing element 202. Further, the progressive sensing area 20 is arranged on the main body 10 at the position corresponding to the position of the electronic sensing element 202 below the LCD panel 201, wherein the progressive sensing area 20 is advantageous in thin, smooth, artistic, dust-proof, scratch-free, and etc. Therefore, the progressive sensing area 20 not only utilizes a progressive non-through hole design, but also enhances the sensibility of the electronic sensing element 202 when the electronic sensing element 202 is operated through the progressive sensing area 20.

According to the present embodiment of the present invention, the progressive sensing area 20 utilizes a progressive non-through hole design, wherein the periphery 21 thereof may be in a shape of square, rectangle, circle, oval, trapezoid, inequilateral shape, and etc., and is gradually shrunk inwards from the periphery 21 in a funnel, curvy or plane slope manner, wherein its thickness is gradually reduced from the top to the bottom. Accordingly, it is capable of helping the reactions of the electronic sensing element 202 (i.e. the fingerprint reader or proximity sensor) be more rapid and stable.

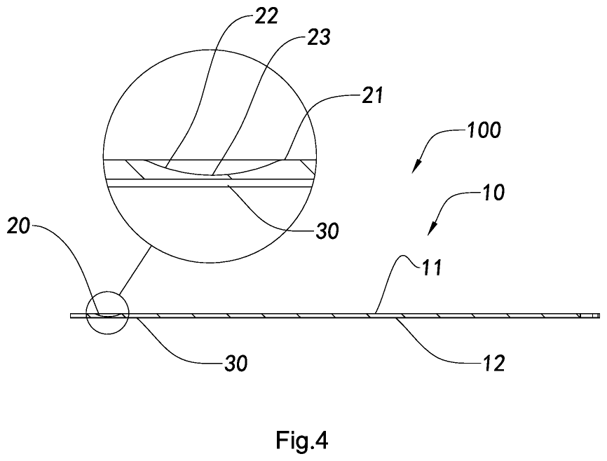

According to the present embodiment of the present invention, referring to FIGS. 4-6, the glass screen protector 100 further comprises a backing 30, wherein the main body 10 of the glass screen protector 100 has an upper surface 11 and a lower surface 12. The backing 30 is arranged on the lower surface 12 for allowing the glass screen protector 100 to be stably attached on the portable mobile electronic device 200. The backing 30 is selected from the group consisting of epoxy resin AB glue, non-backing UV glue, optical adhesive, and combinations thereof, which allows the glass screen protector 100 to be stably attached on the LCD panel 201 of the portable mobile electronic device 200 so as to protect the LCD panel 201.

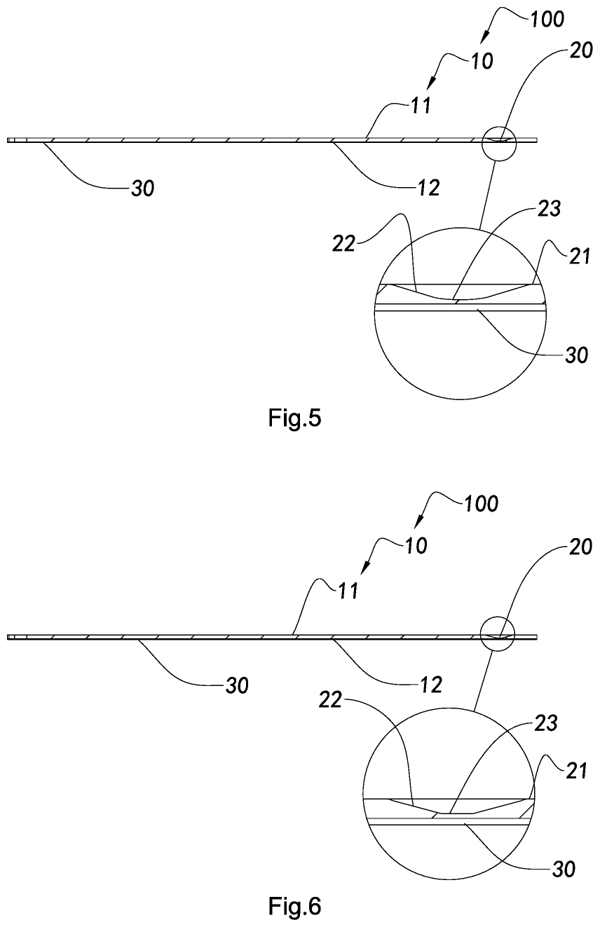

According to the present embodiment of the present invention, the progressive sensing area 20 is formed by progressively reducing the thickness of the main body 10 from the upper surface 11 to the lower surface 12 in a gentle slope manner, which thickness can be as thin as 0.01 mm. Namely, the periphery 21 of the progressive sensing area 20 is sunk inward. In other words, it is concaved from the upper surface 11 toward the lower surface 12. Further, the progressive sensing area 20 has a periphery 21, a sloping side 22, and a bottom side 23, wherein the periphery 21 is smoothly connected with the sloping side 22 and the sloping side 22 is smoothly connected between the periphery 21 and the bottom side 23. The periphery 21 is arranged on the upper surface 11. The size and position of the periphery 21 is arranged based on the electronic sensing element 202. Especially, the periphery 21 has a smooth arc angle, so as to eliminate offset between the sloping side 22 and the upper surface 11. The sloping side 22 slopes inward and downward from the periphery 21, wherein the sloping may be in a curvy or flat manner, wherein this shall not limit the present invention as long as no offset is found from the appearance. The bottom side 23 is curvy or plane and is smoothly connected with the sloping side 22 without offset. Further, referring to FIG. 4, the periphery 21 has a smooth arc angle and the sloping side 22 and the bottom side 23 are curvy surfaces. Referring to FIG. 5, the periphery 21 has a smooth arc angle, the sloping side 22 is a plane surface, and the bottom side 23 is a curvy surface. Referring to FIG. 6, the periphery 21 has a smooth arc angle and the sloping side 22 and the bottom side 23 are plane surfaces.

It is worth mentioning that the thickness of the progressive sensing area 20 of the glass screen protector 100 of the present invention can be gradually turned from 2 mm-0.3 mm to 0.01 mm-0.05 mm without bringing offset texture on the entire glass screen protector 100.

According to the present embodiment of the present invention, the glass screen protector 100 may be made of the material selected from the group consisting of sapphire crystal glass, ceramics glass, sitall glass, aluminosilcate glass, soda-lime glass, and combinations thereof. However, the present invention shall not be limited thereby.

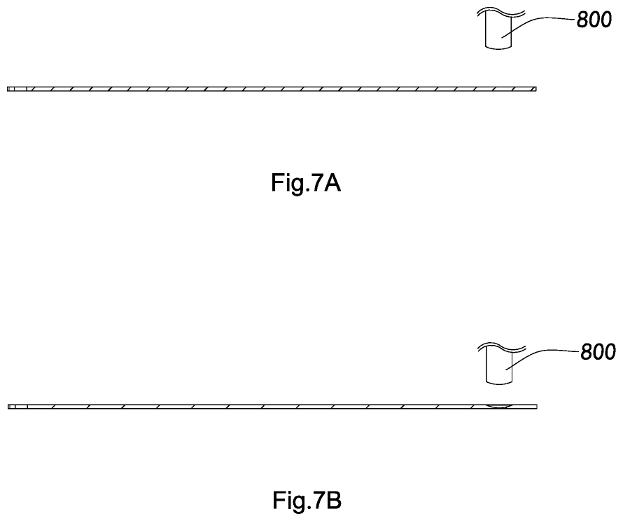

According to the present embodiment of the present invention, the best processing means is to utilize CNC processing to reduce the thickness of the progressive sensing area 20 on the main body 10. Then a polishing process is conducted after the CNC processing, so as to turn the progressive sensing area 20 into a glossy surface. Particularly, the polishing process may only be applied on the progressive sensing area 20 or applied on the entire glass screen protector 100, wherein the present invention shall not be limited thereby. In addition, referring to FIGS. 7A-7B, it has to confirm the position of the progressive sensing area 20 of the glass screen protector 100 before CNC machining. Then a CNC tool 800 is utilized to process the main body 10 in a progressive and gentle slope lowering manner, so as to form the progressive sensing area 20. Finally, a polishing process is introduced to turn the progressive sensing area 20 into a glossy surface, so that eventually the progressive sensing area 20 will be a glossy surface like the main body 10. Further, the best complete process for embodying according to the present invention is to have a glass substrate be cut, CNC processed, and polished, as well as tempered, nano coating coated, and glued, such that a complete glass screen protector 100 can be made. It is worth mentioning that the CNC machining means mentioned is just an example of the present invention, rather than the only processing means. There may also be other processing means, wherein the present invention shall not be limited thereby.

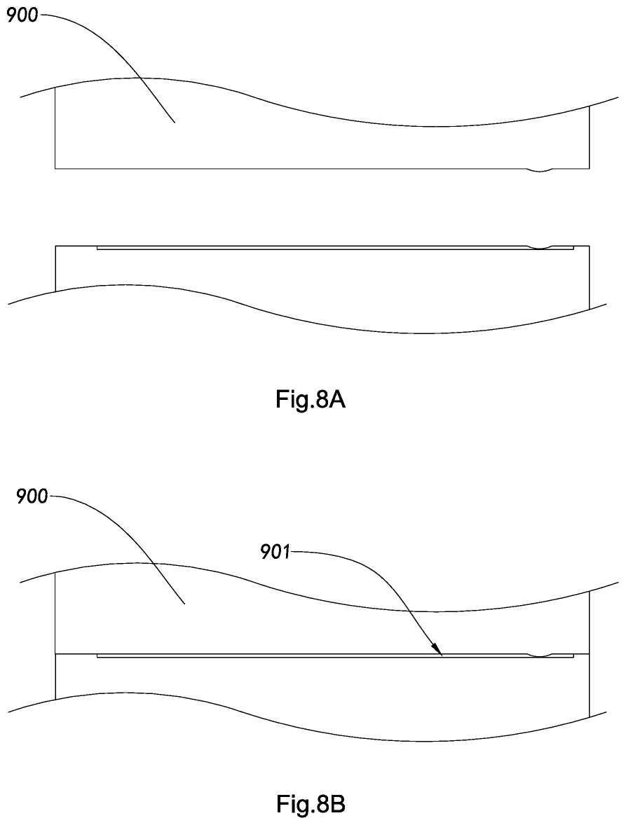

Besides, the present invention may also utilize other processing means to complete the glass screen protector 100 of the present invention, such as utilizing a mold 900 to integrally form the glass screen protector 100. Particularly, referring to FIGS. 8A-8B, the mold 900 can be utilized to form a the glass screen protector 100 with the progressive sensing area 20 completely arranged on the main body 10 directly and allow subsequent tempering process, nano coating process, and gluing process to be carried on. In addition, even also for the molding process, it may only utilize the mold to form a semi-finished glass screen protector 100. Then the progressive sensing area 20 is still made through CNC and polishing processes as well as the subsequent reinforcing, nano coating, and gluing processes. Particularly, a semi-finished glass screen protector 100 formed through the mold 900 requires further CNC machining in order to have the progressive sensing area 20 disposed thereon.

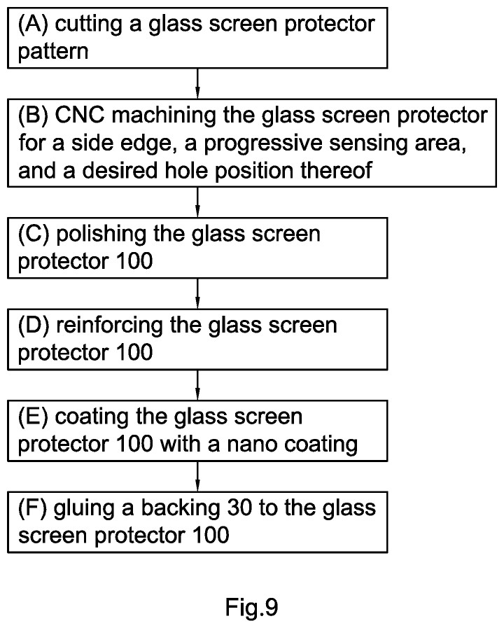

Referring to FIG. 9, the present invention provides a glass screen protector manufacturing method, including the steps of:

(A) cutting a glass screen protector 100 pattern;

(B) CNC machining the glass screen protector 100 for a side edge, a progressive sensing area 20, and a desired hole position thereof;

(C) polishing the glass screen protector 100;

(D) reinforcing the glass screen protector 100;

(E) coating the glass screen protector 100 with a nano coating; and

(F) gluing a backing 30 to the glass screen protector 100.

According to the step (A), the pattern and size of the glass screen protector 100 is determined by the LCD panel 201 of the portable mobile electronic device 200.

According to the step (A), the glass screen protector 100 is made of the material selected from the group consisting of sapphire crystal glass, ceramics glass, sitall glass, aluminosilcate glass, soda-lime glass, and combinations thereof.

According to the step (B), a CNC tool is utilized for the processing, so as to form the progressive sensing area 20 through reducing the thickness of the main body 10 from the upper surface 11 to the lower surface 12 of the main body 10 in a progressive gentle slope manner. The periphery 21 of the progressive sensing area 20 is sunk toward the center, so as to form a progressive gentle slope. The periphery 21 is in a shape selected from the group consisting of square, rectangle, circle, oval, trapezoid, inequilateral shape, and combinations thereof, wherein the thickness is progressively and gradually reduced from the periphery 21 toward the center in a funnel, curvy or flat slope manner. It is worth mentioning that the minimum thickness can be 0.01 mm. Further, the progressive sensing area 20 is a smooth and progressive gentle slope without offset processed through CNC tool. Particularly, the progressive sensing area 20 does not have any through hole or hole breakout.

According to the step (B), the position of the progressive sensing area 20 on the glass screen protector 100, which is corresponding to the position of the electronic sensing element 202 below the LCD panel 201 of the portable mobile electronic device 200, is confirmed before CNC machining.

According to the step (B), the progressive sensing area 20 is in a non-through hole progressive shape after the CNC machining.

According to the step (B), the periphery 21 of the progressive sensing area 20 is in a shape selected from the group consisting of square, rectangle, circle, oval, trapezoid, inequilateral shape, and combinations thereof after the CNC machining.

According to the step (B), the progressive sensing area 20 has a periphery 21, a sloping side 22, and a bottom side 23 after the CNC machining, wherein the sloping side 22 is smoothly connected between the periphery 21 and the bottom side 23. The periphery 21 has a smooth arc angle, so as to eliminate offset between the sloping side 22 and the upper surface 11 of the main body 10. The sloping side 22 is curvy or plane. The bottom side 23 is in a curvy or plane shape. There is no offset among the periphery 21, the sloping side 22, and the bottom side 23. The bottom side 23 can be as thin as 0.01 mm.

According to the step (B), the upper surface 11 of the main body 10 of the glass screen protector 100 matches the position of the electronic sensing element 202 of the portable mobile electronic device 200 and the CNC tool moves according to input designated directions so as to provide a progressive funnel gentle slope, which allows various periphery patterns to be programed in order to partially cut the thickness of the progressive sensing area 20 of the glass screen protector 100 in different extents. It is worth mentioning that the thickness of the progressive sensing area 20 can be turned into as thin as 0.01 mm from the glass of any thickness. For instance, the lowest point of a glass of 0.3 mm of thickness can still be 0.01 mm in a progressively reducing manner.

According to the step (B), the desired hole position may be speaker hole, camera module hole, and etc.

According to the step (C), the glass screen protector 100 has an integral and consistent glossy surface through a partial or whole polishing to the glass screen protector 100.

According to the step (D), the strength and toughness of the glass screen protector 100 is enhanced through high-temperature furnace and potassium nitrate process.

According to the step (E), the upper surface 11 of the glass screen protector 100 is processed with AS/AF nano coating.

According to the step (F), the backing 30 is selected from the group consisting of epoxy resin AB glue, non-backing UV glue, optical adhesive, and combinations thereof.

According to the step (F), the backing 30 is arranged on the lower surface 12 of the glass screen protector 100.

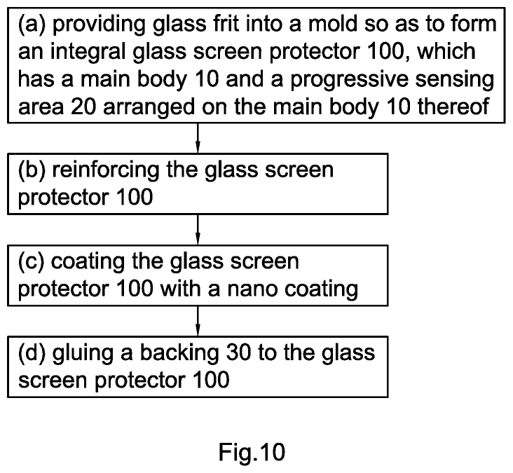

Referring to FIG. 10, the present invention also provides another glass screen protector manufacturing method, including the steps of:

(a) providing glass frit into a mold 900 so as to form an integral glass screen protector 100, which has a main body 10 and a progressive sensing area 20 arranged thereon;

(b) reinforcing the glass screen protector 100;

(c) coating the glass screen protector 100 with a nano coating; and

(d) gluing a backing 30 to the glass screen protector 100.

According to the step (a), the mold has a mold cavity 901 for the glass screen protector 100, which size is corresponding to the size of the LCD panel 201 of the portable mobile electronic device 200.

According to the step (a), the main body 10 and the progressive sensing area 20 of the glass screen protector 100 are integrally formed through mold processing. The position of the progressive sensing area 20 is corresponding to the position of the electronic sensing element 202 below the LCD panel 201 of the portable mobile electronic device 200.

The progressive sensing area 20 is in a non-through hole progressive shape.

The progressive sensing area 20 has a periphery 21, a sloping side 22, and a bottom side 23, wherein the sloping side 22 is smoothly connected between the periphery 21 and the bottom side 23. The periphery 21 has a smooth arc angle, so as to eliminate offset between the sloping side 22 and the upper surface 11 of the main body 10. The sloping side 22 is curvy or plane. The bottom side 23 is in a curvy or plane shape. The periphery 21 is in a shape selected from the group consisting of square rectangle, circle, oval, trapezoid, inequilateral shape, and combinations thereof. There is no offset among the periphery 21, the sloping side 22, and the bottom side 23. The bottom side 23 can be as thin as 0.01 mm.

According to the step (a), the material of the glass frit is selected from the group consisting of sapphire crystal glass, ceramics glass, sitall glass, aluminosilcate glass, soda-lime glass, and combinations thereof.

According to the step (a), the manufacturing method allows the glass screen protector 100 to have a curvy trim.

Particularly, the method further comprises the following steps after the step (a):

(a01) CNC machining the glass screen protector 100 for a desired hole position thereof; and

(a02) polishing the glass screen protector 100.

In other words, the desired hole position that was not integrally formed through molding, may further be provided through CNC machining. The desired hole position may be speaker hole, camera module hole, and etc.

According to the step (a02), the glass screen protector 100 has an integral and consistent glossy surface through a partial or whole polishing to the glass screen protector 100.

According to the step (b), the strength and toughness of the glass screen protector 100 is enhanced through high-temperature furnace and potassium nitrate process.

According to the step (c), the upper surface 11 of the glass screen protector 100 is processed with AS/AF nano coating.

According to the step (d), the backing 30 is selected from the group consisting of epoxy resin AB glue, non-backing UV glue, optical adhesive, and combinations thereof.

According to the step (d), the backing 30 is arranged on the lower surface 12 of the glass screen protector 100.

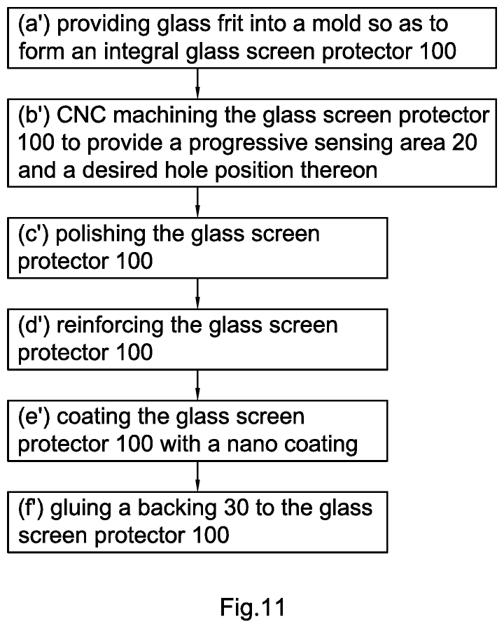

Referring to FIG. 11, the present invention also provides another glass screen protector manufacturing method, including the steps of:

(a′) providing glass frit into a mold so as to form an integral glass screen protector 100;

(b′) CNC machining the glass screen protector 100 for a progressive sensing area 20 and a desired hole position thereof;

(c′) polishing the glass screen protector 100;

(d′) reinforcing the glass screen protector 100;

(e′) coating the glass screen protector 100 with a nano coating; and

(f) gluing a backing 30 to the glass screen protector 100.

It is worth mentioning that the glass screen protector 100 provided by the present method does not have an integrally formed progressive sensing area 20.

According to the step (b′), the position of the progressive sensing area 20 on the glass screen protector 100, which is corresponding to the position of the electronic sensing element 202 below the LCD panel 201 of the portable mobile electronic device 200, is confirmed before CNC machining.

According to the step (b′), the progressive sensing area 20 is in a non-through hole progressive shape after the CNC machining.

According to the step (b′), the periphery 21 of the progressive sensing area 20 is in a shape selected from the group consisting of square, rectangle, circle, oval, trapezoid, inequilateral shape, and combinations thereof after the CNC machining.

According to the step (b′), the progressive sensing area 20 has a periphery 21, a sloping side 22, and a bottom side 23 after the CNC machining, wherein the sloping side 22 is smoothly connected between the periphery 21 and the bottom side 23. The periphery 21 has a smooth arc angle, so as to eliminate offset between the sloping side 22 and the upper surface 11 of the main body 10. The sloping side 22 is curvy or plane. The bottom side 23 is in a curvy or plane shape. There is no offset among the periphery 21, the sloping side 22, and the bottom side 23. The bottom side 23 can be as thin as 0.01 mm.

According to the step (d′), the strength and toughness of the glass screen protector 100 is enhanced through high-temperature furnace and potassium nitrate process.

According to the step (e′), the upper surface 11 of the glass screen protector 100 is processed with AS/AF nano coating.

According to the step (f), the backing 30 is selected from the group consisting of epoxy resin AB glue, non-backing UV glue, optical adhesive, and combinations thereof.

According to the step (f), the backing 30 is arranged on the lower surface 12 of the glass screen protector 100.

One skilled in the art will understand that the embodiment of the present invention as shown in the drawings and described above is exemplary only and not intended to be limiting. It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

All in all, though the preferred embodiment of the present invention has been disclosed above, it shall not limit the scope of the present invention. All equivalent alternatives of change and modification within the spirit and scope of the present invention that can easily be made by person skilled in the art shall still be within the patent scope of the present invention. Hence, the drawings or content of the present specification shall not be utilized as a limitation of the present invention and the scope of the present invention shall be based on the appended claims.

What is claimed is:

1. A glass screen protector manufacturing method, comprising the steps of:
(A) cutting a glass screen protector pattern;
(B) CNC machining the glass screen protector for a side edge, a progressive sensing area without through hole, and a desired hole position thereof;
(C) polishing the glass screen protector;
(D) reinforcing the glass screen protector;
(E) coating the glass screen protector with a nano coating; and
(F) gluing a backing to the glass screen protector.

2. The glass screen protector manufacturing method, as recited in claim 1, wherein in the step (A), the pattern and size of the glass screen protector is determined by the LCD panel of the portable mobile electronic device.

3. The glass screen protector manufacturing method, as recited in claim 1, wherein in the step (A), the glass screen protector is made of the material selected from the group consisting of sapphire crystal glass, ceramics glass, sitall glass, aluminosilcate glass, soda-lime glass, and combinations thereof.

4. The glass screen protector manufacturing method, as recited in claim 1, wherein in the step (B), the position of the progressive sensing area on the glass screen protector, which is corresponding to the position of the electronic sensing element below the LCD panel of the portable mobile electronic device, is confirmed before CNC machining.

5. The glass screen protector manufacturing method, as recited in claim 1, wherein in the step (B), a CNC tool is utilized for processing the glass screen protector and forming the progressive sensing area.

6. The glass screen protector manufacturing method, as recited in claim 5, wherein is the step (B), the CNC tool moves according to input designated directions so as to provide a progressive funnel gentle slope, which allows various periphery patterns to be programed in order to partially cut the thickness of the progressive sensing area of the glass screen protector in different extents.

7. The glass screen protector manufacturing method, as recited in claim 1, wherein in the step (B), the progressive sensing area is in a progressive shape without through hole after the CNC machining, wherein the peripheral outline of the progressive sensing area is in a shape selected from the group consisting of square, rectangle, circle, oval, trapezoid, inequilateral shape, and combinations thereof.

8. The glass screen protector manufacturing method, as recited in claim 1, wherein in the step (B), after the CNC machining, the progressive sensing area has a periphery, a sloping side, and a bottom side, wherein the sloping side is smoothly connected between the periphery and the bottom side, wherein the periphery has a smooth arc angle, so as to eliminate the offset between the sloping side and the upper surface of the main body of the glass screen protector, wherein the sloping side is curvy or plane, wherein the bottom side is curvy or plane.

9. The glass screen protector manufacturing method, as recited in claim 1, wherein the minimum thickness of the progressive sensing area is 0.01 mm.

10. The glass screen protector manufacturing method, as recited in claim 1, wherein in the step (C), the glass screen protector has an integral and consistent glossy surface through a partial or whole polishing to the glass screen protector.

11. The glass screen protector manufacturing method, as recited in claim 1, wherein in the step (D), the strength and toughness of the glass screen protector is enhanced through high-temperature furnace and potassium nitrate process.

12. The glass screen protector manufacturing method, as recited in claim 1, wherein in the step (E), the upper surface of the glass screen protector is processed with AS/AF nano coating.

13. The glass screen protector manufacturing method, as recited in claim 1, wherein in the step (F), the backing is selected from the group consisting of epoxy resin AB glue, non-backing UV glue, optical adhesive, and combinations thereof.

14. A glass screen protector manufacturing method, comprising the steps of:
(a) providing glass frit into a mold so as to form an integral glass screen protector, which has a main body and a progressive sensing area arranged thereon;
(b) reinforcing the glass screen protector;
(c) coating the glass screen protector with a nano coating; and
(d) gluing a backing to the glass screen protector.

15. The glass screen protector manufacturing method, as recited in claim 14, wherein in the step (a), the mold has a mold cavity for the glass screen protector, which size is corresponding to the size of the LCD panel of the portable mobile electronic device.

16. The glass screen protector manufacturing method, as recited in claim 14, wherein in the step (a), the progressive sensing area has a periphery, a sloping side, and a bottom side, wherein the sloping side is smoothly connected between the periphery and the bottom side, wherein the periphery has a smooth arc angle, so as to eliminate the offset between the sloping side and the upper surface of the main body of the glass screen protector.

17. The glass screen protector manufacturing method, as recited in claim 16, wherein the sloping side and the bottom side have a shape selected from the group consisting of curvy and plane.

18. The glass screen protector manufacturing method, as recited in claim 14, wherein in the step (a), the glass screen protector has a curvy trim.

19. A glass screen protector manufacturing method, comprising the steps of:
(a′) providing glass frit into a mold so as to form an integral glass screen protector;
(b′) CNC machining the glass screen protector to provide a progressive sensing area and a desired hole position thereon, wherein the progressive sensing area is in a progressive non-through hole manner;
(c′) polishing the glass screen protector;
(d′) reinforcing the glass screen protector;
(e′) coating the glass screen protector with a nano coating; and
(f) gluing a backing to the glass screen protector.

20. The glass screen protector manufacturing method, as recited in claim 19, wherein in the step (b′), after the CNC machining, the progressive sensing area has a periphery, a sloping side, and a bottom side, wherein the sloping side is smoothly connected between the periphery and the bottom side, wherein the periphery has a smooth arc angle, so as to eliminate the offset between the sloping side and the upper surface of the main body of the glass screen protector, wherein the sloping side is selectively curvy or plane, wherein the bottom side is selectively curvy or plane.
